(19) United States
(12) Patent Application Publication
(10) Pub. No.: US 2026/0148478 A1
(43) Pub. Date: May 28, 2026

(54) REAL-TIME HIGH-FIDELITY ADAPTIVE VOXEL RADIANCE FIELD RENDERING

(71) Applicant: NVIDIA CORPORATION, Santa Clara, CA (US)

(72) Inventors: Cheng SUN, Hsinchu (TW); Jaesung CHOE, Taipei (TW); Charles LOOP, Mercer Island, WA (US); Yu-Chiang WANG, Taipei (TW)

(21) Appl. No.: 19/349,779

(22) Filed: Oct. 3, 2025

Related U.S. Application Data
(60) Provisional application No. 63/725,879, filed on Nov. 27, 2024.

(51) Int. Cl. G06T 15/08; G06T 15/06

(52) U.S. Cl. CPC G06T 15/08; G06T 15/06

(57) ABSTRACT

Various embodiments include techniques for rendering an image. The techniques include allocating a plurality of voxels to represent a scene, sorting the plurality of voxels based on a plurality of associated Morton codes to obtain a rendering order, and rendering the plurality of voxels based on the rendering order to generate an image.

### CROSS-REFERENCE TO RELATED APPLICATIONS

This application claims priority benefit of the United States Provisional Patent Application titled, “TECHNIQUES FOR REAL-TIME HIGH-FIDELITY RADIANCE FIELD RENDERING,” filed on Nov. 27, 2024 and having Ser. No. 63/725,879. The subject matter of that related application is hereby incorporated herein by reference.

### BACKGROUND

### Technical Field

Various embodiments relate generally to computer science and computer graphics and, more specifically, to real-time high-fidelity adaptive voxel radiance field rendering.

### Description of the Related Art

Computing systems that include processing units, such a central processing unit (CPU) and a graphics processing unit (GPU), multiple CPUs, multiple GPUs, and/or the like, can be used to render images from three-dimensional (3D) representations of scenes. Conventional graphics pipelines for rendering images oftentimes use 3D assets that are modeled manually. Alternatively, image-based three-dimensional (3D) reconstruction can be used to automatically generate a 3D scene from input images capturing the scene, and the automatically-generated 3D scene can be used to render images from various viewpoints.

One approach for image-based 3D reconstruction is neural radiance field (NeRF), which uses a neural field to reconstruct a 3D representation of a scene from images. NeRF implementations can be used to represent scenes using a multilayer perceptron (MLP). NeRF variants render an image by casting a ray through each pixel and sampling many points on the casted ray to query the MLP for geometric and appearance properties. One shortcoming of NeRF implementations is that NeRF typically is very computationally expensive, resulting in slow frame per second (FPS) rendering.

Another approach for image-based 3D reconstruction is 3D Gaussian Splatting (3DGS). 3DGS is a radiance field rendering technique that represents 3D scenes using 3D Gaussians (ellipsoidal shapes) with parameters for position, color, opacity, and shape. 3DGS approaches perform real-time rendering and high visual quality by directly rendering explicit Gaussians using a differentiable tile-based rasterizer and bypassing the computationally intensive neural network queries of approaches such as NeRF. However, 3DGS approaches are based on Gaussian center positions, which are oftentimes inaccurate and can cause a popping artifact where details appear to flicker as a viewer moves through a scene. Additionally, a 3D volume from Gaussians of a 3DGS approach is not well defined, making 3DGS incompatible with many computer graphics algorithms that could otherwise be used to reconstruct surfaces, such as 3D meshes, from the Gaussians.

As the foregoing illustrates, what is needed in the art are more effective techniques for image-based 3D reconstruction.

### SUMMARY

One embodiment of the present disclosure sets forth a method for rendering an image. The method includes allocating a plurality of voxels to represent a scene, sorting the plurality of voxels based on a plurality of associated Morton codes to obtain a rendering order, and rendering the plurality of voxels based on the rendering order to generate an image.

Another embodiment of the present disclosure sets forth a method for representing a scene using voxels. The method includes initializing a first plurality of voxels that represent a scene, and performing one or more iterative optimization operations based on the first plurality of voxels and one or more images of the scene to generate a second plurality of voxels that represent the scene.

Other embodiments include, without limitation, a system that implements one or more aspects of the disclosed techniques, and one or more computer readable media including instructions for performing one or more aspects of the disclosed techniques.

At least one technical advantage of disclosed techniques relative to the prior art is that the disclosed techniques allow for relatively fast frame per second (FPS) rendering. Another technical advantage is that the disclosed techniques can be used to render higher quality images that include fewer popping artifacts than images rendered from the Gaussians of 3DGS approaches. In addition, the disclosed techniques provide a well-defined volume due to the different voxel sizes, making the voxels compatible with various computer graphics algorithms such as, for example, marching cubes techniques and truncated signal distance function fusion (TSDF-fusion). These technical advantages provide one or more technological improvements over prior art approaches.

### BRIEF DESCRIPTION OF THE DRAWINGS

So that the manner in which the features of the various embodiments recited herein can be understood in detail, a more particular description of the inventive concepts, briefly summarized herein, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the parallel processing subsystem of FIG. 1, according to various embodiments;

FIG. 3 is a block diagram of a general processing cluster (GPC) included in the parallel processing unit of FIG. 2, according to various embodiments;

FIG. 4 is a more detailed illustration of radiance field application of FIG. 1, according to various embodiments;

FIG. 5 illustrates an example voxel representation of a scene using sparse voxels, according to various embodiments;

FIG. 6 illustrates how the optimization module of the radiance field application of FIG. 1 generates a voxel representation of a scene, according to various embodiments;

FIG. 7 is a flow diagram of method steps for rendering of voxels into images, according to various embodiments;

FIG. 8 is a flow diagram of method steps for rendering pixels included in a two-dimensional image, according to various embodiments;

FIG. 9 illustrates an exemplar Morton ordering, according to various embodiments;

FIG. 10 illustrates another exemplar Morton ordering, according to various embodiments; and

FIG. 11 is a flow diagram of method steps for reconstructing a 3D voxel representation from images, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

Embodiments of the present disclosure provide techniques for generating a set of voxels (also referred to herein as a “voxel representation”) to represent a scene. A size of each voxel in the set of voxels is based on a level of detail in a corresponding portion of the scene. That is, the voxels are adaptively fit into the different sizes for different levels of detail in the scene rather than using uniform size voxels. The voxels are used to represent 3D scenes using efficient rasterization-based rendering, while ensuring that rendering occurs in the correct order. Scene optimization is implemented so that the voxels are adaptively fit into different scene levels of detail, and the scenes are reproduced with good rendering quality.

The techniques for generating and rendering images using a set of voxels have many real-world applications. For example, those techniques could be used to render images of various scenes. As another example, those techniques could be used to reconstruct surfaces of scenes, such as for surface mesh extraction. As further examples, those techniques could be used to obtain two dimensional (2D) foundation features by volume fusion, to obtain language features, and/or the like.

The above examples are not in any way intended to be limiting. As persons skilled in the art will appreciate, as a general matter, the techniques for generating voxels, optimization of the voxels, and rendering images using the voxels that are described herein can be implemented in any suitable applications.

### System Overview

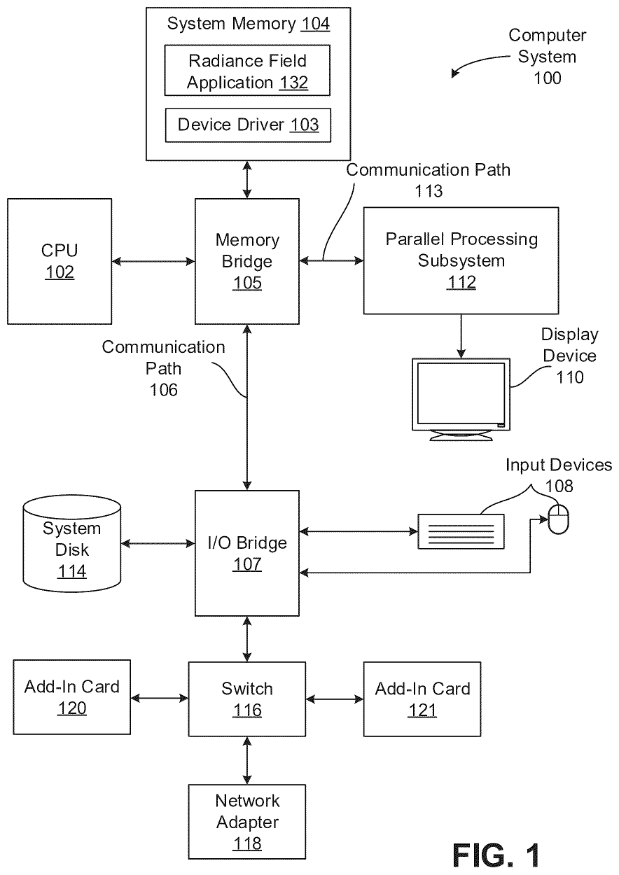

FIG. 1 is a block diagram of a computing system 100 configured to implement one or more aspects of the various embodiments. As shown, computing system 100 includes, without limitation, a central processing unit (CPU) 102 and a system memory 104 coupled to a parallel processing subsystem 112 via a memory bridge 105 and/or a communication path 113. Memory bridge 105 is further coupled to an I/O (input/output) bridge 107 via a communication path 106, and/or I/O bridge 107 is, in turn, coupled to a switch 116.

In operation, I/O bridge 107 is configured to receive user input information from input devices 108, such as a keyboard or a mouse, and/or forward the input information to CPU 102 for processing via communication path 106 and/or memory bridge 105. Switch 116 is configured to provide connections between I/O bridge 107 and/or other components of the computing system 100, such as a network adapter 118 and/or various add-in cards 120 and 121. In some examples, without limitation, network adapter 118 serves as the primary or exclusive input device to receive input data for processing via the disclosed techniques.

As also shown, I/O bridge 107 is coupled to a system disk 114 that can be configured to store content and/or applications and/or data for use by CPU 102 and/or parallel processing subsystem 112. As a general matter, system disk 114 provides non-volatile storage for applications and/or data and can include fixed or removable hard disk drives, flash memory devices, and/or CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and/or the like, can be connected to I/O bridge 107 as well.

In various embodiments, memory bridge 105 can be a Northbridge chip, and/or I/O bridge 107 can be a Southbridge chip. In addition, communication paths 106 and/or 113, as well as other communication paths within computing system 100, can be implemented using any technically suitable protocols, including, without limitation, Peripheral Component Interconnect Express (PCIe), HyperTransport, or any other bus or point-to-point communication protocol known in the art.

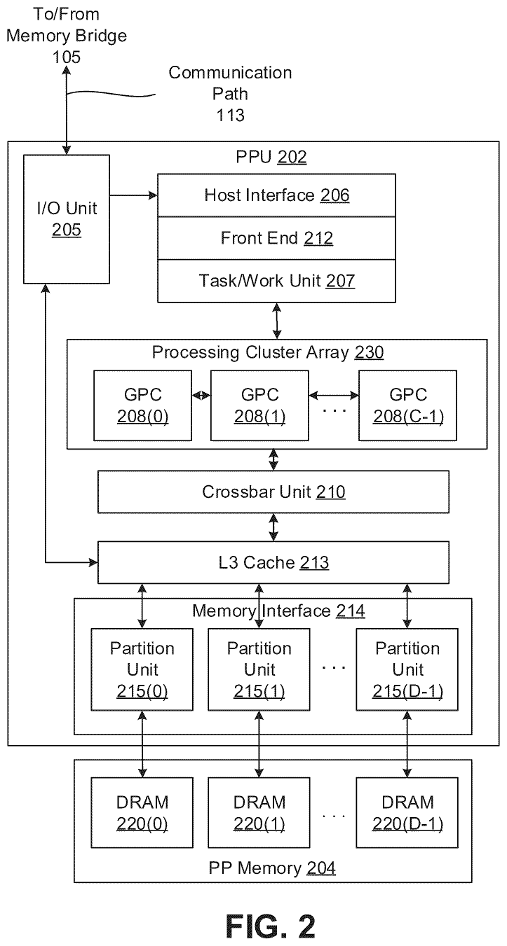

In some embodiments, parallel processing subsystem 112 comprises a graphics subsystem that delivers pixels to a display device 110 that can be any conventional cathode ray tube, liquid crystal display, light-emitting diode display, or the like. In such embodiments, the parallel processing subsystem 112 incorporates circuitry optimized for graphics and/or video processing, including, for example, without limitation, video output circuitry. As described in greater detail herein in FIG. 2, such circuitry can be incorporated across one or more parallels included within parallel processing subsystem 112. Parallel processing subsystem 112 includes one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural processing unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, parallel processing subsystem 112 includes two processors, referred to herein as a primary processor (normally a CPU) and/or a secondary processor. Typically, the primary processor is a CPU and/or the secondary processor is a GPU. Additionally or alternatively, each of the primary processor and/or the secondary processor can be any one or more of the types of parallels disclosed herein, in any technically feasible combination. The secondary processor receives secure commands from the primary processor via a communication path that is not secured. The secondary processor accesses a memory and/or other storage system, such as system memory 104, Compute eXpress Link (CXL) memory expanders, memory managed disk storage, on-chip memory, and/or the like. The secondary processor accesses this memory and/or other storage system across an insecure connection. The primary processor and/or the secondary processor can communicate with one another via a GPU-to-GPU communications channel, such as NVIDIA Link (NVLink). Further, the primary processor and/or the secondary processor can communicate with one another via network adapter 118. In general, the distinction between an insecure communication path and/or a secure communication path is application dependent. A particular application program generally considers communications within a die or package to be secure. Communications of unencrypted data over a standard communications channel, such as PCIe, are considered to be unsecure.

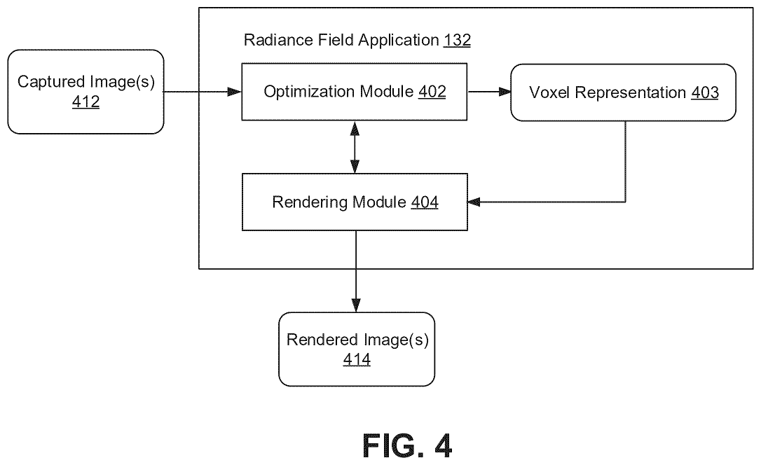

In some embodiments, the parallel processing subsystem 112 incorporates circuitry optimized for general purpose and/or compute processing. Again, such circuitry can be incorporated across one or more parallel processing units included within parallel processing subsystem 112 that are configured to perform such general purpose and/or compute operations. In yet other embodiments, the one or more parallel processing units included within parallel processing subsystem 112 can be configured to perform graphics processing, general purpose processing, and/or compute processing operations. System memory 104 includes at least one device driver 103 configured to manage the processing operations of the one or more parallels within parallel processing subsystem 112. System memory 104 also includes a radiance field application 132 in accordance with some embodiments. Radiance field application 132 is discussed in greater detail below in conjunction with FIGS. 4-11.

In various embodiments, parallel processing subsystem 112 can be integrated with one or more of the other elements of FIG. 1 to form a single system. For example, without limitation, parallel processing subsystem 112 can be integrated with CPU 102 and/or other connection circuitry on a single chip to form a system on chip (SoC).

It will be appreciated that the system shown herein is illustrative and that variations and/or modifications are possible. The connection topology, including the number and/or arrangement of bridges, the number of CPUs 102, and/or the number of parallel processing subsystems 112, can be modified as desired. For example, without limitation, in some embodiments, system memory 104 can be connected to CPU 102 directly rather than through memory bridge 105, and/or other devices would communicate with system memory 104 via memory bridge 105 and/or CPU 102. In other alternative topologies, parallel processing subsystem 112 can be connected to I/O bridge 107 or directly to CPU 102, rather than to memory bridge 105. In still other embodiments, I/O bridge 107 and/or memory bridge 105 can be integrated into a single chip instead of existing as one or more discrete devices. Lastly, in certain embodiments, one or more components shown in FIG. 1 can not be present. For example, without limitation, switch 116 can be eliminated, and/or network adapter 118 and/or add-in cards 120, 121 would connect directly to I/O bridge 107.

FIG. 2 is a block diagram of a parallel processing unit (PPU) 202 included in the parallel processing subsystem 112 of FIG. 1, according to various embodiments. Although FIG. 2 depicts one PPU 202, as indicated herein, parallel processing subsystem 112 can include any number of PPUs 202. Further, the PPU 202 of FIG. 2 is one non-limiting example of a parallel included in parallel processing subsystem 112 of FIG. 1. Alternative parallels include, without limitation, CPUs, GPUs, DMA units, IPUs, NPUs, TPUs, NNPs, DPUs, VPUs, ASICs, FPGAs, and/or the like. The techniques disclosed in FIGS. 2-4 with respect to PPU 202 apply equally to any type of parallel(s) included within parallel processing subsystem 112, in any combination. As shown, PPU 202 is coupled to a local parallel processing (PP) memory 204. PPU 202 and/or PP memory 204 can be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that can be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 can be used to store and/or update pixel data and/or deliver final pixel data or display frames to display device 110 for display. In some embodiments, PPU 202 also can be configured for general-purpose processing and/or compute operations.

In operation, CPU 102 is the master processor of computing system 100, controlling and/or coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that can be located in system memory 104, PP memory 204, or another storage location accessible to both CPU 102 and/or PPU 202. Additionally or alternatively, processors and/or processing units other than CPU 102 can write one or more streams of commands for PPU 202 to a data structure. A pointer to the data structure is written to a pushbuffer to initiate processing of the stream of commands in the data structure. The PPU 202 reads command streams from the pushbuffer and/or then executes commands asynchronously relative to the operation of CPU 102. In embodiments where multiple pushbuffers are generated, execution priorities can be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and/or memory bridge 105. I/O unit 205 generates packets (or other signals) for transmission on communication path 113 and/or also receives all incoming packets (or other signals) from communication path 113, directing the incoming packets to appropriate components of PPU 202. For example, without limitation, commands related to processing tasks can be directed to a host interface 206, while commands related to memory operations (e.g., reading from or writing to PP memory 204) can be directed to a crossbar unit 210. Host interface 206 reads each pushbuffer and/or transmits the command stream stored in the pushbuffer to a front end 212.

As mentioned herein in conjunction with FIG. 1, the connection of PPU 202 to the rest of computing system 100 can be varied. In some embodiments, parallel processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 can be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and/or stored in memory. The pointers to TMDs are included in a command stream that is stored as a pushbuffer and received by front end 212 from host interface 206. Processing tasks that can be encoded as TMDs include indices associated with the data to be processed as well as state parameters and/or commands that define how the data is to be processed. For example, without limitation, the state parameters and/or commands can define the program to be executed on the data. Task/work unit 207 receives tasks from front end 212 and/or ensures that GPCs 208 are configured to a valid state before the processing task specified by each one of the TMDs is initiated. A priority can be specified for each TMD that is used to schedule the execution of the processing task. Processing tasks also can be received from processing cluster array 230. Optionally, the TMD can include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 can be allocated for processing different types of programs or for performing different types of computations. The allocation of GPCs 208 can vary depending on the workload arising for each type of program or computation. As will be described in more detail herein, one or more GPCs 208 can concurrently execute threads in a cooperative thread array (CTA) that cooperate and share data to perform collective computations.

In the illustrated example of FIG. 2, PPU 202 further includes a level three (L3) cache memory, or L3 cache, 213. As will be described in more detail herein, L3 cache 213 is shared by GPCs 208 included in PPU 202. In a cache hierarchy, L3 cache 213 is positioned further upstream from streaming multiprocessors (SMs) executing threads than level one (L1) and level two (L2) caches included in PPU 202. In some examples, such as in the illustrated example of FIG. 2, L3 cache 213 is the highest level cache (HLC) in a cache hierarchy. In some examples, PPU 202 and/or parallel processing subsystem 112 includes one or more additional levels of cache (e.g., level four (L4) cache, level five (L5) cache, etc.) that are positioned further upstream in a cache hierarchy. In some examples, the PPU does not include an L3 cache 213. In such examples, the L2 caches included in the PPU 202 are at the highest level of cache in the PPU 202 and/or parallel processing subsystem 112.

L3 cache 213 is coupled to a memory interface 214. Memory interface 214 includes a set D of partition units 215, where D≥1. Each partition unit 215 is coupled to one or more dynamic random access memories (DRAMs) 220 residing within PP memory 204. In one embodiment, the number of partition units 215 equals the number of DRAMs 220, and/or each partition unit 215 is coupled to a different DRAM 220. In other embodiments, the number of partition units 215 can be different than the number of DRAMs 220. In some embodiments, one or more caches, such as L3 cache 213, can also be partitioned. For example, every L3 cache partition could handle read and write accesses for a specific address range. In such cases, a scope tree, discussed in greater detail below in conjunction with FIGS. 4-19, can be created for each address range.

Persons of ordinary skill in the art will appreciate that a DRAM 220 can be replaced with any other technically suitable storage device. In operation, various render targets, such as texture maps and/or frame buffers, can be stored across DRAMs 220, allowing partition units 215 to write portions of each render target in parallel to efficiently use the available bandwidth of PP memory 204.

A given GPC 208 can process data to be written to any of DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 can use virtual channels to separate traffic streams between the GPCs 208 and/or partition units 215.

Again, GPCs 208 can be programmed to execute processing tasks relating to a wide variety of applications, including, without limitation, linear and/or nonlinear data transforms, filtering of video and/or audio data, modeling operations (e.g., applying laws of physics to determine position, velocity, and/or other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and/or write result data back to system memory 104 and/or PP memory 204. The result data can then be accessed by other system components, including CPU 102, another PPU 202 within parallel processing subsystem 112, or another parallel processing subsystem 112 within computing system 100.

As noted herein, any number of PPUs 202 can be included in a parallel processing subsystem 112. For example, without limitation, multiple PPUs 202 can be provided on a single add-in card, or multiple add-in cards can be connected to communication path 113, or one or more of PPUs 202 can be integrated into a bridge chip. PPUs 202 in a multi-PPU system can be identical to or different from one another. For example, without limitation, different PPUs 202 might have different numbers of processing cores and/or different amounts of PP memory 204. In implementations where multiple PPUs 202 are present, those PPUs can be operated in parallel to process data at a higher throughput than is possible with a single PPU 202. Systems incorporating one or more PPUs 202 can be implemented in a variety of configurations and/or form factors, including, without limitation, desktops, laptops, handheld personal computers or other handheld devices, servers, workstations, game consoles, embedded systems, and/or the like.

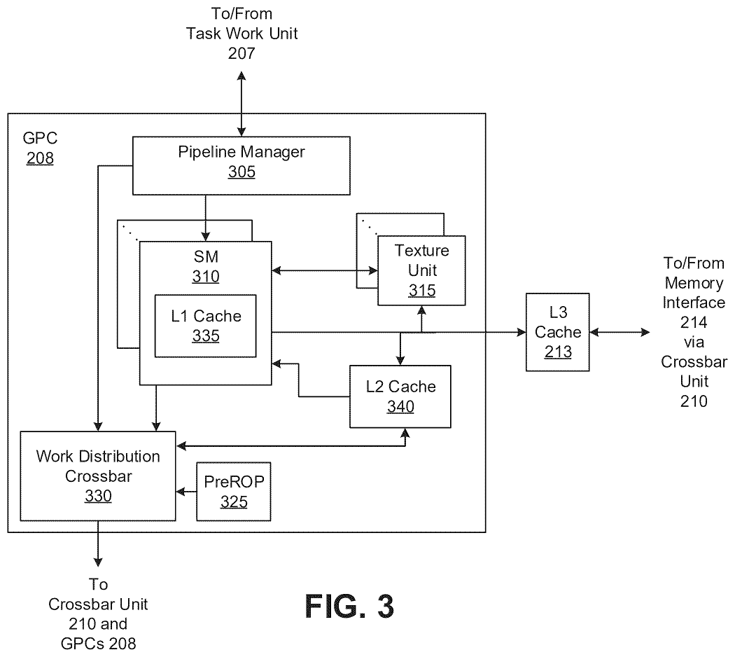

FIG. 3 is a block diagram of a general processing cluster (GPC) 208 included in the parallel processing unit (PPU) 202 of FIG. 2, according to various embodiments. In operation, GPC 208 can be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 can also be configured to control a work distribution crossbar 330 by specifying destinations for processed data output by SMs 310.

In one embodiment, GPC 208 includes a set of Q SMs 310, where Q≥1. Also, each SM 310 includes a set of functional execution units (not shown), such as execution units and/or load-store units. Processing operations specific to any of the functional execution units can be pipelined, which enables a new instruction to be issued for execution before a previous instruction has completed execution. Any combination of functional execution units within a given SM 310 can be provided. In various embodiments, the functional execution units can be configured to support a variety of different operations including integer and/or floating point arithmetic (e.g., addition and/or multiplication), comparison operations, Boolean operations (e.g., AND, OR, XOR), bit-shifting, and/or computation of various algebraic functions (e.g., planar interpolation and/or trigonometric, exponential, and/or logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group can include fewer threads than the number of execution units within SM 310, in which case some of the execution can be idle during cycles when that thread group is being processed. A thread group can also include more threads than the number of execution units within SM 310, in which case processing can occur over consecutive clock cycles and/or across multiple SMs 310. Since each SM 310 can support up to G thread groups concurrently, it follows that up to G*Q thread groups can be executing in GPC 208 at any given time.

Additionally, a plurality of related thread groups can be active (in different phases of execution) at the same time within one or more SMs 310. This collection of thread groups is referred to herein as a “cooperative thread array” (“CTA”) or “thread array.” The size of a particular CTA is equal to q*k, where k is the number of concurrently executing threads in a thread group, which is typically an integer multiple of the number of execution units within SM 310, and q is the number of thread groups simultaneously active within the one or more SMs 310. In various embodiments, a software application written in the compute unified device architecture (CUDA) programming language describes the behavior and/or operation of threads executing on GPC 208, including any of the behaviors and/or operations described herein. A given processing task can be specified in a CUDA program such that SM 310 can be configured to perform and/or manage general-purpose compute operations.

As will be described in more detail herein, each SM 310 is coupled to a private level one (L1) cache memory, or L1 cache, 335 that supports, among other things, load and/or store operations performed by the execution units. Each SM 310 in a particular GPC 208 also has access to a level two (L2) cache, or L2 cache, 340 that is shared among all SMs 310 in the particular GPC 208 and L3 cache 213 that is shared among GPCs 208 in PPU 202. L2 caches 340 and L3 cache 213 can be used to transfer data between threads. Persons skilled in the art will understand that the three levels of caches illustrated in FIGS. 2 and 3 are provided as non-limiting examples of cache memory, and that in other examples, a PPU 202 can include and/or be coupled to fewer or more than two levels of cache. In some examples, PPU 202 includes and/or is coupled to two levels of cache memory. In other examples, PPU 202 includes and/or is coupled to four levels of cache memory, five levels of cache memory, or some other number of levels of cache memory.

In addition to various levels of cache memory, SMs 310 also have access to off-chip “global” memory, which can include PP memory 204 and/or system memory 104. It is to be understood that any memory external to PPU 202 can be used as global memory. As shown in FIGS. 2 and 3, L3 cache 213 and/or L2 caches 340 can be configured to receive and/or hold data requested from memory via memory interface 214 by an SM 310. Such data can include, without limitation, instructions, uniform data, and/or constant data. As will be described in more detail herein, each GPC 208 can have an associated memory management unit (MMU) that is configured to map virtual addresses into physical addresses. In various embodiments, MMU can reside either within GPC 208 or within memory interface 214. The MMU includes a set of page table entries (PTEs) used to map a virtual address to a physical address of a tile or memory page and/or optionally a cache line index. The MMU can include address translation lookaside buffers (TLB) or caches that can reside within SMs 310, within one or more L1 caches 335, one or more L2 caches 340, L3 cache 213, and/or within GPC 208. In some examples, the MMU includes or is in addition to the scope tree and coherence protocol controllers described herein with respect to the different levels of cache memory.

In graphics and/or compute applications, GPC 208 can be configured such that each SM 310 is coupled to a texture unit 315 for performing texture mapping operations, such as determining texture sample positions, reading texture data, and/or filtering texture data.

In operation, each SM 310 transmits a processed task to work distribution crossbar 330 in order to provide the processed task to another GPC 208 for further processing or to store the processed task in an L2 cache 340 or an L3 cache 213, parallel processing memory 204, or system memory 104 via crossbar unit 210. In addition, a pre-raster operations (preROP) unit 325 is configured to receive data from an SM 310, direct data to one or more raster operations (ROP) units within partition units 215, perform optimizations for color blending, organize pixel color data, and/or perform address translations.

### Radiance Field Rendering

FIG. 4 is a more detailed illustration of radiance field application 132 of FIG. 1, according to various embodiments. As shown, radiance field application 132 includes, without limitation, an optimization module 402 and a rendering module 404.

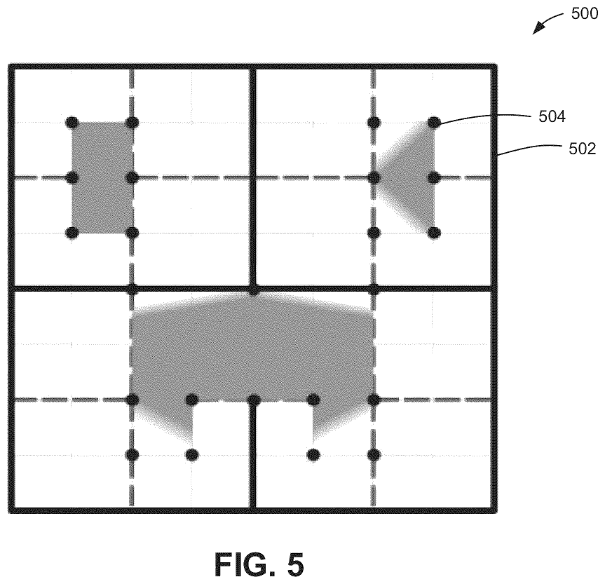

In operation, optimization module 402 performs an optimization technique to generate a voxel representation of a 3D scene, shown as voxel representation 403, from input frames of at least one captured image 412. Optimization module 402 receives at least one captured image 412 of the scene and processes the captured image(s) 412 to generate sparse voxels of voxel representation 403 that represent the scene. It is assumed herein that the camera poses associated with received images (e.g., captured image(s) 412) are known and/or can be determined using known techniques. In some embodiments, module 402 adaptively fits the voxels in the set of voxels into different scene levels of detail in captured image(s) 412, as described in greater detail below in conjunction with FIGS. 5-6 and 11. In such cases, optimization module 402 initializes a voxel grid layout by initially assigning voxels to a main region of particular interest with smaller sized voxels in a dense grid and by initially assigning voxels to at least one less dense background region with larger sized voxels. Optimization module 402 computes a maximum blending weight for each voxel, and periodically prunes voxels based on associated blending weights so that voxels likely to be allocated to empty space are deleted. Optimization module 402 also periodically subdivides voxels (e.g., into 2×2 children voxels) based on a training loss gradient that indicates whether regions require finer detail for high precision geometry or high frequency appearance. Optimization module 402 performs multiple iterations of the optimization using captured image(s) 412 to generate voxel representation 403.

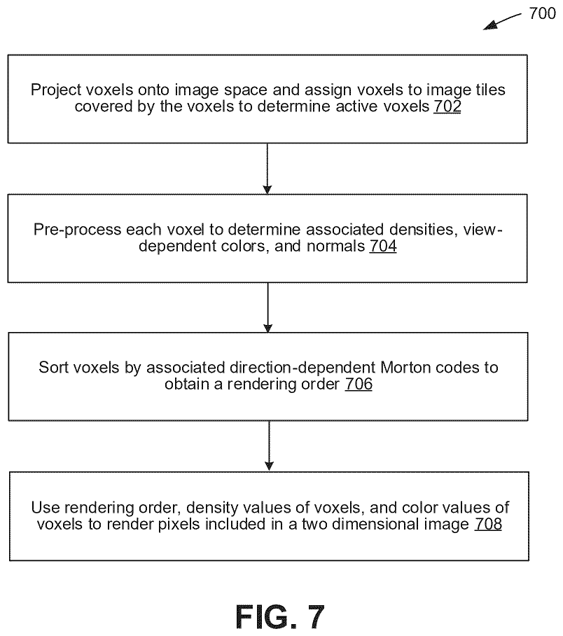

Rendering module 404 receives 3D voxel representation 403 generated by optimization module 402 and renders image(s) 414 of the scene from desired viewpoint(s) based on voxel representation 403. Once generated, the set of voxels in voxel representation 403 can be rendered by rendering module 404 into the rendered image(s) 414 using a rasterization technique. In some embodiments, during rendering, a ray direction-dependent Morton ordering is used to render the voxels of voxel representation 403 in a correct order, as described in greater detail below in conjunction with FIGS. 7-10. Rendered image(s) 414 can be displayed on a display device such as display device 110 in some embodiments.

FIG. 5 illustrates an example voxel representation 500 of a scene using sparse voxels, according to various embodiments. As shown, voxel representation 500 illustrates, without limitation, sparse voxels 502 and voxel corner grid points 504 in a two dimensional (2D) visualization. Some voxels 502 and corner grid points 504 are shown with reference numerals in FIG. 5, but not all reference numbers are shown for clarity of the figure. Some of the corner grid points 504 are shown as black dots in FIG. 5. Shaded areas within voxel representation 500 illustrate areas of higher density relative to other areas. As illustrated in FIG. 5, voxels 502 can be allocated under an Octree layout.

Each voxel 502 has its own Spherical Harmonic (SH) coefficient for view-dependent appearance. The color field of each voxel 502 is approximated for efficiency purposes as a constant inside the voxel when rendering. The density field of each voxel 502 can be trilienarly varied inside the voxel and is modeled the density values on the corner grid points 504 of each voxel 502 (including the black dots in FIG. 5 as well as other corner grid points of each voxel). In some embodiments, densities at the corner grid points 504 are shared between adjacent voxels 502.

In some embodiments, sparse voxels 502 are of different sizes depending on a level of detail of a voxel represented by the particular voxel 502. Optimization module 402 can allocate voxels 502 following an Octree space partition rule (that is, an Octree layout) as illustrated in FIG. 5. This Octree layout facilitates a correct rendering order of voxels 502 with various sizes for optimization module 402, and allows optimization module 404 to adaptively fit the sparse voxels to different scene level-of-details, for example. In some embodiments, voxel representation 500 does not replicate a traditional Octree data structure with parent-child pointers or linear Octree, but rather only keeps voxels at the Octree leaf nodes without any ancestor nodes. As a result of using an Octree layout in this manner, rendering module 404 can project voxels 502 to image space and guarantee that all voxels are in a correct order when rendering. Individual voxels can be stored in arbitrary order without any need to maintain a more complex data structure.

In some embodiments, optimization module 402 allocates voxels to represent a scene following an Octree layout without any ancestor nodes. The voxels are cubes that can be allocated into different levels of a grid. As described herein, smaller voxels can be used in higher frequency areas and larger voxels can be used in lower frequency areas. In some embodiments, the voxels can be stored using a data structure that stores different levels of voxels with larger and smaller sizes. In such cases, each level can store voxels whose sides are half the sides of voxels stored in a previous level.

In some embodiments, optimization module 402 sets up a grid layout to allocate the voxels and constructs 3D scenes using a sparse voxel representation. Optimization module 402 allocates voxels following an Octree space partition rule to achieve high-quality results, including facilitating a correct rendering order of voxels with various sizes, adaptively fitting the sparse voxels to different scene level-of-details. In some embodiments, the rendering module does not replicate a traditional Octree data structure with parent-child pointers or linear Octree, and keeps only voxels at the Octree leaf nodes without any ancestor nodes. Optimization module 402 can be implemented as a sorting-based rasterizer that projects voxels to image space and guarantees that all voxels are in a correct order during rendering. In some embodiments, rendering module 404 stores individual voxels in an arbitrary order without the need to maintain a more complex data structure while still ensuring the correct rendering order. Since the rendering module 404 allocates voxels following an Octree layout but does not replicate a traditional Octree data structure with parent-child pointers or linear Octree, the rendering module 404 only keep voxels at the Octree leaf nodes without any ancestor nodes and stores individual voxels in arbitrary order without the need to maintain a more complex data structure.

In some embodiments, optimization module 402 chooses a maximum level of detail L of 16 that defines a maximum grid resolution at (2^{L})³. An Octree size of wₛ is used (wₛ∈ [symbol] ), and an Octree center in world space of w_{c} is used (w_{c}∈ [symbol] ). A voxel index v={i,j,k}∈[0, . . . , 2^{L-1}]³ together with an Octree level l∈[1,L] (l=0 represent root node and is not used) define voxel size vₛ and voxel center v_{c} as follows in Equations 1A and 1B:

$${v}_{s} = {w}_{s} \cdot {2}^{- l} \qquad EQUATION 1 A$$

$${v}_{c} = {w}_{c} - 0.5 \cdot {w}_{s} + {v}_{s} \cdot ( v + 0.5 ) . \qquad EQUATION 1 B$$

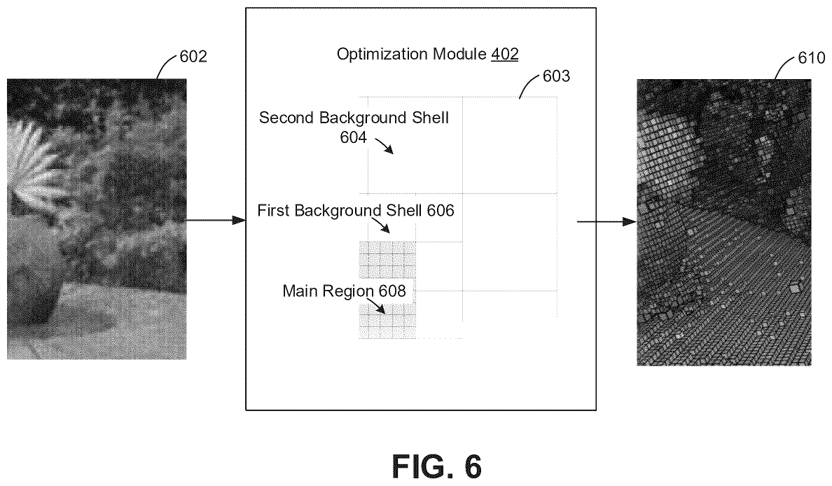

FIG. 6 illustrates how optimization module 402 of radiance field application 132 generates a voxel representation of a scene, according to various embodiments. As shown, optimization module 402 receives as input one or more images of a scene, shown as image 602. Optimization module 402 initializes a grid layout of an initial voxel representation 603 by initially assigning voxels to a main region 608 of particular interest with smaller sized voxels in a dense grid and by initially assigning voxels to at least one less dense background region with larger sized voxels, shown as first background shell 606 and second background shell 604. Although initial voxel representation 603 is shown in 2D for illustrative purposes, it should be understood that initial voxel representation 603 is a 3D voxel representation. Although described herein primarily with respect to initial voxel representations with a main region and less dense background region(s) as a reference example, it should be understood that the different regions are hyperparameters and, in some embodiments, only a main region can be used with no background regions for the initial voxel representation.

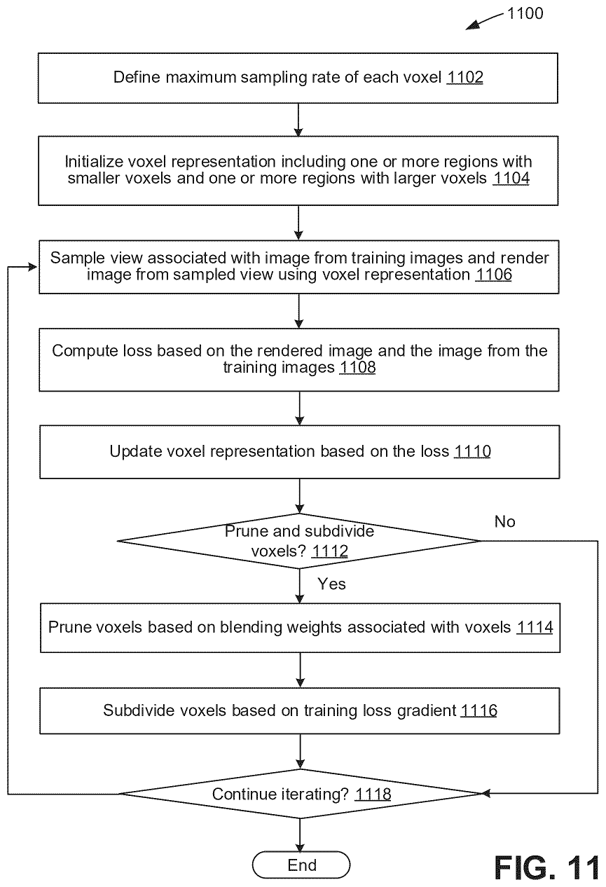

Optimization module 402 performs optimization beginning with initial voxel representation 603 and proceeds iteratively to create and optimize the voxels of the voxel representation. In some embodiments, the voxel representation includes voxels with parameters that include color, alpha value for density, normal, and depth. The color can start as a gray color and develop over the iteration process. In the beginning, smaller voxels in main region 608 can be included in a middle portion of the scene and/or with more detail, and larger voxels can be included in other areas such as first background shell 606 and second background shell 606. The optimization process can turn the gray scene voxels into voxels with different color values, alpha values, and geometric values. The differential rendering process can begin with no colors in which the scene appears gray. The scene that is rendered from the voxel representation from a sampled viewpoint can then be compared with an actual image from training data that is associated with the same viewpoint, and the difference can be used to compute a loss and update parameters of the voxels of the voxel representation, including the color values, alpha values, and geometric values. Optimization module 402 also periodically prunes voxels based on the associated maximum blending weight for each voxel so that voxels likely to be allocated to empty space are deleted. In some embodiments, optimization module 402 periodically subdivides voxels (e.g., into 2×2 children voxels) based on a training loss gradient that indicates whether regions require finer detail for high precision geometry or high frequency appearance. Optimization module 402 performs multiple iterations of the optimization using captured image(s) 412 to generate voxel representation 610, as discussed in greater detail below in conjunction with FIG. 11.

FIG. 7 is a flow diagram of method steps for rendering of voxels into images, according to various embodiments. Although the method steps of the flow diagram illustrated in FIG. 7 are described in conjunction with the embodiments of FIGS. 1-6, persons of ordinary skill in the art will understand that in some embodiments any system can be configured to perform the method steps of the flow diagram of FIG. 7 in any order.

As shown, a method 700 begins at step 702, where rendering module 404 projects voxels of the voxel representation into image space and assigns the voxels to image tiles (also called image patches) covered by the voxels to determine active voxels. Voxels that are not assigned to image tiles are not active voxels. References to voxels hereinafter in method 700 will refer to active voxels. Each image tile is, for example, a number of image patches (such as 16×16 image patches in some embodiments). In some embodiments, a particular voxel can be assigned to any number of image tiles (for example, some voxels can be assigned to one image tile, some voxels can be assigned to more than one image tile, and/or some voxels can be assigned to zero image tiles). In some embodiments, rendering module 404 causes eight corner points of each voxel to be projected into image space, and that voxel is assigned to all tiles overlapped with an axis-aligned bounding box formed by the projected eight points.

At step 704, rendering module 404 pre-processes each voxel to determine associated densities, view-dependent colors, and normals. Step 704 is performed only for voxels assigned to image tiles at step 702. In some embodiments, rendering module 404 gathers, for active voxels assigned to tiles of the target view, densities v_{geo} from grid points of the voxels, computes view-dependent colors from associated SH coefficients, and/or derives voxel normals, and can also determine and gather other geometry and appearance information. Rendering module 404 can share the pre-processed voxel properties among all pixels during rendering. The densities from grid points of the voxels as well as other gathered geometry and/or appearance information can be gathered from a memory in which the densities and/or other geometry and/or appearance information are stored, for example. In addition, rendering module 404 can determine and/or gather voxel color and cache computed color volumes in some embodiments. It is noted that it is not necessary to re-compute some of the values such as color value and normal value for each array. In some embodiments, values can be computed once for each voxel during pre-processing and can be re-used for all the rays involving that voxel.

At step 706, rendering module 404 sorts voxels by associated direction-dependent Morton codes to obtain a rendering order. In some embodiments, one or more voxels can be assigned to each tile, and such voxels are sorted in order to obtain a correct rendering order. For accurate rasterization, primitive rendering order is important. For example, using centers of the voxels (such as primitive centers) or their closest distance to the camera can produce incorrect ordering, producing popping artifacts. However, in some embodiments, rendering module 404 can accurately sort by Morton order using a voxel representation due to the allocation of voxels without any ancestor nodes as described herein.

In some embodiments, rendering module 404 can follow certain types of Morton order to render the voxels under an Octree node for correct ordering. The type of Morton order to follow can be dependent on the positive/negative signs of the ray direction where the ray origin does not matter, which allows eight permutations of Morton order for different ray directions in 3D space.

In some embodiments, rendering module 404 sorts the voxels using a per-tile voxel sorting technique. In such cases, rendering module 404 can apply the sorting for each image tile. In cases where all the pixels in a tile share the same ray direction signs, rendering module 404 can simply sort the assigned voxels by their type of Morton order.

In some embodiments, a goal in the sorting stage of the rasterizer implemented by rendering module 404 is to arrange a list of voxels in near-to-far order for each image tile. In some embodiments, rendering module 404 attaches a key-value pair, where a tile index is assigned as the most significant bits of the sorting key and a dynamic Morton order is assigned as the least significant bits of the sorting key. In this manner, voxels assigned to the same image tile will be in a consecutive array segment after sorting with near to far depth ordering.

In some embodiments, rendering module 404 uses a direction-dependent Morton order of voxels to ensure the rendering order is always correct. Since there are eight different Morton orders to follow depending on the positive/negative signs of ray directions (also identified by ray sign bits), the rendering module 404 further duplicates each voxel by the numbers of different ray sign bits that the voxel covers. The ray sign bits are also attached to each duplicated voxel. In the rendering stage, a pixel only composites voxels with the same attached ray sign bits when there are multiple ray sign bits in an image tile. An example of a bit field of the key-value pair according to some embodiments is shown in equations 2A and 2B as follows:

$$key = \vert {\underbrace{tile id}}_{16 bits} \vert {\underbrace{Morton order}}_{48 ( = 3 L ) bits} \vert \qquad EQUATION 2 A$$

$$value = \vert {\underbrace{ray sign bits}}_{3 bits} \vert {\underbrace{voxel id}}_{29 bits} \vert , \qquad EQUATION 2 B$$

where L=16 is the maximum number of Octree levels. In some embodiments, the “voxel id” is indexed to a 1D array location where the voxel is stored. It is noted that such a bit field arrangement is an implementation that can conveniently be used for, e.g., 64 bit and 32 bit unsigned integer values. Any number of bits can be used in some embodiments.

Since rendering module 404 allocates voxels following an Octree layout but does not replicate a traditional Octree data structure with parent-child pointers or linear Octree, rendering module 404 only keeps voxels at the Octree leaf nodes without any ancestor nodes and stores individual voxels in arbitrary order without the need to maintain a more complex data structure. Rendering module 404 can map the grid index to an associated Morton code using a bit interleaving operation, which is beneficial in implementing rendering. An example of how rendering module 404 can map between voxel grid index and Octree Morton code octpath is shown in the following pseudocode.

```
MAX_NUM_LEVELS = 16
def to_octpath(i, j, k, lv):
  # Input
  # (i,j,k): voxel index.
  # lv: Octree level.
  # Output
  # octpath: Morton code
  octpath: int = 0
  for n in range(lv):
    bits = 4*(i&1) + 2*(j&1) + (k&1)
    octpath |= bits << (3*n)
    i = i >> 1
    j = j >> 1
    k = k >> 1
  octpath = octpath << (3*(MAX_NUM_LEVELS-lv))
  return octpath
def to_voxel_index(octpath, lv):
  # Input
  # octpath: Morton code
  # lv: Octree level.
  # Output
  # (i,j,k): voxel index.
  i: int = 0
  j: int = 0
  k: int = 0
  octpath = octpath >> (3*(MAX_NUM_LEVELS-lv))
  for n in range(lv):
    i |=((octpath&0b100)>>2) << n
    j |= ((octpath&0b010)>>1) << n
    k |= ((octpath&0b001)) << n
    octpath = octpath >> 3
  return (i, j, k)
```

In some embodiments, rendering module 404 can map from Octree Morton code to dynamic Morton code using a single bitwise xor operation. In some other embodiments, rendering module 404 can map from Octree Morton code to dynamic Morton code using other techniques.

As described herein, there are eight types of Morton order to follow, each of which is for a certain type of positive/negative signs pattern of ray directions. In some embodiments, rendering module 404 can hard-code the eight types of Morton orders, which is used to remap every non-overlapping three bits (corresponding to different Octree levels) in the Octree Morton code of voxels. For example, according to the following: . . . bₓb_{y}b_{z}aₓa_{y}a_{z} [symbol] . . . f^{(k)} (bₓb_{y}b_{z})f^{(k)}(aₓa_{y}a_{z}), where f^{(k)}: [0 . . . ] [symbol] [0 . . . 7] is one of the eight permutation mappings.

An example of how rendering module 404 can compute the ray sign bits and can map from Octree Morton code to dynamic direction-dependent Morton code is shown in the following pseudocode.

```
MAX_NUM_LEVELS = 16
order_tables = [
  $[0,1,2,3,4,5,6,7]$,
  $[1,0,3,2,5,4,7,6]$,
  $[2,3,0,1,6,7,4,5]$,
  $[3,2,1,0,7,6,5,4]$,
  $[4,5,6,7,0,1,2,3]$,
  $[5,4,7,6,1,0,3,2]$,
  $[6,7,4,5,2,3,0,1]$,
  $[7,6,5,4,3,2,1,0]$,
]
def to_rd_signbits(rd):
  \# Input
  \# rd: Ray direction.
  \# Output
  \# signbits: Ray sign bits.
  return $4 *(\operatorname{rd}[0]<0)+2 *(\operatorname{rd}[1]<0)+(\operatorname{rd}[2]<0)$
def to_dir_dep_morton_order(octpath, signbits):
  \# Input
  \# octpath: Voxel Octree Morton code.
  \# signbits: The signbits the voxel care.
  \# Output
  \# order: The order for sorting.
  table = order_tables[signbits]
  order $=0$
  for i in range (MAX_NUM_LEVELS) :
    order |= table[octpath \& Ob111] << ( $3 * i$ )
    octpath = octpath >> 3
  return order
```

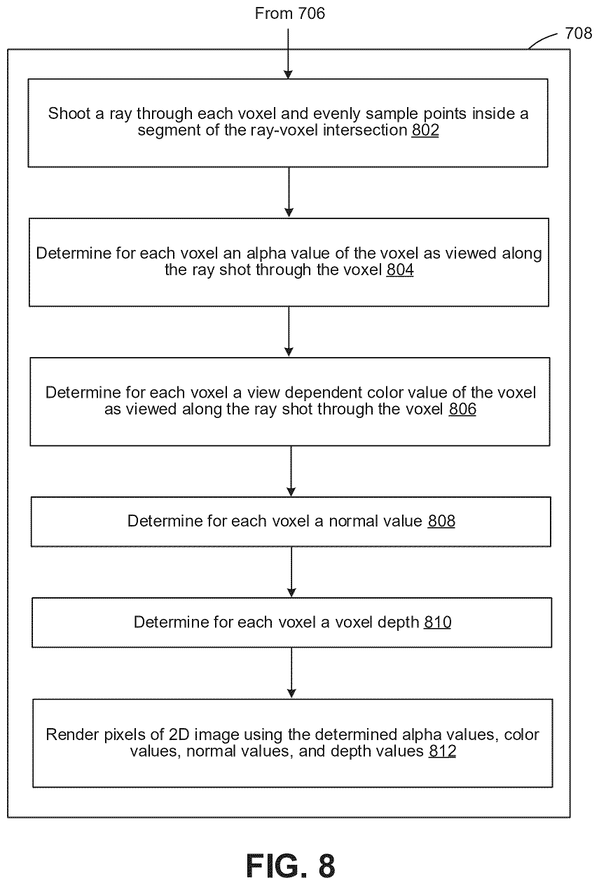

At step 708, rendering module 404 uses the rendering order, density values of voxels, and color values of voxels, to render pixels included in a two dimensional (2D) image. The rendering module 404 can render pixels by, among other things, using alpha composition according to Equation 3:

$$C = {\sum }_{i = 1}^{N} {T}_{i} \cdot {α}_{i} \cdot {c}_{i} , {T}_{i} = {\prod }_{j = 1}^{i - 1} ( 1 - {α}_{j} ) , \qquad EQUATION 3$$

where αᵢ∈ [symbol] and cᵢ∈ [symbol] are alpha and view-dependent color at the i-th sampled point or primitive on the pixel-ray. The quantity Tᵢ is the transmittance. In some embodiments, rendering module 404 can blend N primitives of a pixel-ray depending on a number of sparse voxels assigned to the tile to which the pixel-ray belongs. The rendering module 404 can compute the alpha, color, and other geometric properties from the sparse voxels of the voxel representation, as discussed in greater detail below in conjunction with FIG. 8. When rendering sparse voxels for a pixel-ray, rendering module 404 can compute ray-aabb intersection to determine the ray segment to sample (for voxel alpha, for example), and skip some non-intersected sparse voxels. Rendering module 404 can perform an early termination of the alpha composition if the transmittance of a sparse voxel is below a threshold (Tᵢ<h_{T}). In some embodiments, the rendering module 404 performs anti-aliasing to mitigate aliasing artifacts. The rendering module can render in hₛₛ times higher resolution and then apply image downsampling to the target resolution with an anti-aliasing filter in some embodiments.

FIG. 8 is a flow diagram of method steps for rendering pixels included in a two-dimensional image, according to various embodiments. Although the method steps of the flow diagram illustrated in FIG. 8 are described in conjunction with the embodiments of FIGS. 1-6, persons of ordinary skill in the art will understand that in some embodiments any system can be configured to perform the method steps of the flow diagram of FIG. 8 in any order.

As shown, step 708 begins at step 802, where rendering module 404 shoots a ray through each voxel and evenly samples points inside a segment of the ray-voxel intersection. In some embodiments, the rays that are shot through the voxels can each be sampled uniformly inside a voxel, up to a maximum sampling rate of each voxel (e.g., 3 samples), described in greater detail below in conjunction with FIG. 11.

At step 804, rendering module 404 determines for each voxel an alpha value of the voxel as viewed along the ray shot through the voxel. The alpha value can be determined using a density field. Rendering module 404 derives several geometric properties for composite rendering of each voxel, including the alpha value. For scene geometry, rendering module 404 uses eight parameters corresponding to 3D corners of the voxel to model a trilinear density field inside each voxel, denoted as v_{geo}∈ [symbol] . Sharing corners among adjacent voxels results in a continuous density field.

Rendering module 404 also uses an activation function to ensure a nonnegative density value for the raw density from v_{geo}. For this purpose, rendering module 404 can use exponential linear activation according to Equation 4 as follows:

$$explin ( x ) = \{ \begin{matrix}x & if x > 1.1 \\ exp ( \frac{x}{1.1} - 1 + ln 1.1 ) & otherwise\end{matrix} \qquad EQUATION 4$$

To derive the alpha value a of a voxel contributing to the alpha composition, the rendering module evenly samples K points in the ray segment of ray-voxel intersection. The rendering module 404 can use Equation 5 for numerical integration for volume rendering as follows:

$$α = 1 - exp ( - \frac{l}{K} {\sum }_{k = 1}^{K} explin ( interp ( {v}_{g e o} , {q}_{k} ) ) ) , \qquad EQUATION 5$$

where α is the density value of the voxel as viewed along the ray, I is the ray segment length, k is the sample point number within the ray and voxel cube intersection, v_{geo} is an eight corner density value including eight density values stored in each voxel for each of the eight corners of the voxel, qₖ is the local voxel coordinate of the k-th sample point within the ray and voxel cube intersection, and interp (.) indicates trilinear interpolation. Equation 5 helps to interpolate to obtain the density value using triangulation. In this manner, the activation function of Equation 4 can be used to map the interpolation value into a non-negative density value.

At step 806, rendering module 404 determines for each voxel a view dependent color value of the voxel viewed along the ray shot through the voxel. Rendering module 404 can determine voxel view-dependent color from spherical harmonics. To model view-dependent scene appearance, rendering module 404 uses N_{shd} degree SH. For increased efficiency, assume that SH coefficients stay constant inside a voxel, denoted as vₛₕ∈ [symbol] . In some embodiments, rendering module 404 approximates voxel colors as a function of a direction from the camera position rₒ to the voxel center v_{c} instead of using an individual ray direction r_{d} using Equation 6 as follows:

$$c = max ( 0 , sh\_eval ( {v}_{s h} , normalize ( {v}_{c} - {r}_{o} ) ) ) , \qquad EQUATION 6$$

where c is the view-dependent color intensity of the voxel contributing to the pixel composition of Equation 6. Equation 6 can be used to provide a spherical harmonics version of the voxel colors based on the viewing direction. Due to the approximation, the resulting SH color of a voxel can be shared by all covered pixels in the image rather than evaluating the SH for each intersecting ray.

At step 808, rendering module 404 determines for each voxel a normal value. In some embodiments, rendering of other features or properties is similar to rendering a color image by replacing the color term c in Equation 6 with a target modality like the normal of a voxel density field. For rendering efficiency, rendering module 404 assumes that the normal stays constant inside a voxel, which is represented by an analytical gradient of the density field at the voxel center as in Equation 7 as follows:

$$\vec{n} = normalize ( {∇}_{q} interp ( {v}_{g e o} , {q}_{c} ) ) , \qquad EQUATION 7$$

where q_{c}=(0.5,0.5,0.5) and closed-form equations can be used for forward and backward passes. In Equation 7, v_{geo} is an eight corner density value, and q_{c} is a center position of the voxel. Equation 7 provides a gradient of the density field which is then normalized so that 2D views can be rendered. The rendering module 404 can compute the differentiable voxel normal in a manner similar to the SH colors by computing them once in pre-processing and sharing them for all the intersecting rays in the image.

At step 810, rendering module 404 determines for each voxel a voxel depth. Rendering module 404 can efficiently compute point depths to composite. Unlike colors and normals, the same K points can be sampled as in the voxel alpha value in Equation 6 for a more precise depth rendering. In some embodiments, the rendering module 404 can manually expand and simplify forward and backward computation for a small number of K.

At step 812, rendering module 404 renders pixels of a 2D image using the determined alpha values, color values, normal values, and depth values. In some embodiments, rendering module 404 can render pixels using alpha composition according to Equation 3 using the density values determined according to Equation 5, and rendering module 404 can blend N primitives of a pixel-ray depending on a number of sparse voxels assigned to the tile to which the pixel-ray belongs, as described above in conjunction with FIG. 7.

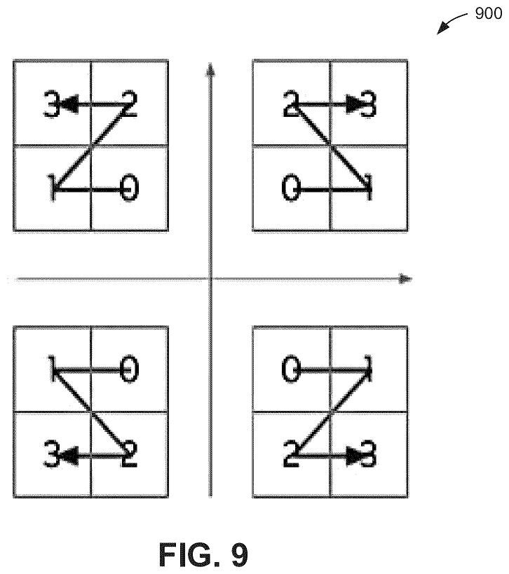

FIG. 9 illustrates an exemplar Morton ordering 900, according to various embodiments. As shown, Morton ordering 900 includes four types of Morton order in a 2D world. Morton ordering 900 can be computed as described above in conjunction with FIG. 7. In some embodiments, the voxel rendering order (in 0, 1, 2, 3 order in each of the four Morton order types illustrated in FIG. 9) under an Octree node is dependent on which world quadrant to which the ray direction is pointing.

As illustrated in FIG. 9, rendering module 404 can follow certain types of Morton order to render voxels under an Octree node for correct ordering. In some embodiments, the type of Morton order to follow is solely dependent on positive/negative signs of the ray direction and the ray origin doesn't matter. For example, eight permutations of Morton order could be used for different ray directions in 3D space.

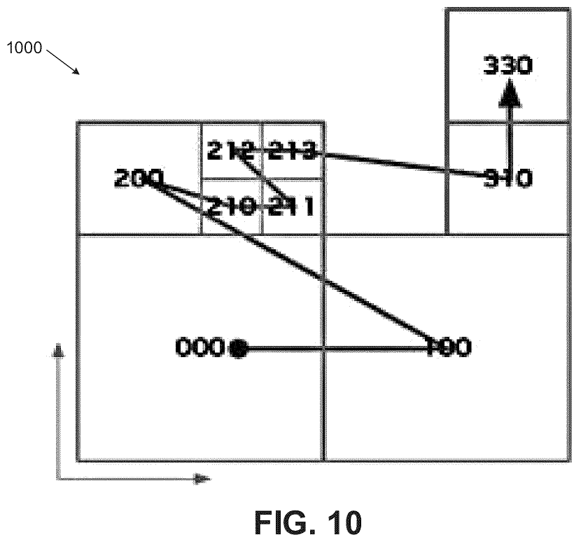

FIG. 10 illustrates another exemplar Morton ordering 1000, according to various embodiments. As shown, Morton ordering 1000 provides an ordering example in 2D with three levels. Morton ordering 1000 can be computed as described above in conjunction with FIG. 7. Illustratively, Morton ordering 1000 provides an example of sorting using Morton order encoding (for example, in 000, 100, 200, 210, 211, 212, 213, 310, 330 order in FIG. 10). In some embodiments, all the ray directions going toward the upper right quadrant can use the sorted voxels for a correct rendering order.

FIG. 11 is a flow diagram of method steps for reconstructing a 3D voxel representation from images, according to various embodiments. Although the method steps of the flow diagram illustrated in FIG. 11 are described in conjunction with the systems of FIGS. 1-6, persons of ordinary skill in the art will understand that in some embodiments any system can be configured to perform the method steps of the flow diagram of FIG. 11 in any order.

As shown, a method 1100 begins at step 1102, where optimization module 402 defines a maximum sampling rate of each voxel. The maximum sampling rate vᵣₐₜₑ of each voxel is defined by optimization module 402 on training images, which reflect the image region a voxel can cover. A smaller vᵣₐₜₑ indicates that the voxel is more prone to overfitting due to less observation. The voxel maximum sampling rate vᵣₐₜₑ is used in a voxel initialization process and a voxel subdivision process implemented by the optimization module 402. In some embodiments, given N_{cam} training cameras, the maximum sampling rate of a voxel can be estimated by the optimization module 402 as follows according to Equations 8A and 8B as follows:

$${v}_{rate} = {max}_{i}^{{N}_{cam}} \frac{{v}_{s}}{{v}_{interval}^{( i )}} \qquad EQUATION 8 A$$

$${v}_{i n terval}^{( i )} = {\underbrace{{( {v}_{c} - {r}_{o}^{( i )} )}^{⊤} {ℓ}^{( i )}}}_{Voxel z - distance} \cdot {\underbrace{\frac{tan ( 0.5 \cdot {θ}_{fov - x}^{( i )} )}{0.5 \cdot {W}^{( i )}}}}_{Unit - distance pixel size} , \qquad EQUATION 8 B$$

where v_{c} is a voxel center

$$, {r}_{o}^{( i )}$$

is a camera origin location, [symbol] is a camera lookat vector, θ_{fov-x} is a camera horizontal field of view, and W is an image width. The sampling rate indicates an estimated number of rays along an image's horizontal axis direction that may hit the voxel.

At step 1104, optimization module 402 initializes a voxel representation including one or more foreground main regions with smaller voxels and one or more background regions with larger voxels. A foreground main region can have different shell levels than the background regions, as described above in conjunction with FIG. 6. In some embodiments, smaller voxels are used in higher frequency areas and larger voxels are used in higher frequency areas. In some embodiments, the voxels can be stored using a data structure that stores different levels of voxels with larger and smaller sizes. In such cases, each level can store voxels whose sides are half the length of the sides of voxels stored in a previous level. The main region can be an area that is initially perceived to be objects with detail, an indoor region, and/or an area of the scene of high interest, while the background regions can be areas initially perceived to be buildings, far outdoor objects, the sky, areas without variations, and/or an area of little interest, for example. In some embodiments, optimization module 402 can initialize all parameters to constant values. Volume density can be set by optimization module 402 to a level approaching zero by setting voxel raw density to a negative number h_{geo} so that an initial activated density explin(h_{geo})≈0. In some embodiments, optimization module 402 sets voxel SH coefficients to zero for non-zero degrees and sets a view-independent zero-degree component to yield gray color (for example, an intensity equal to 0.5).

As discussed above, in some embodiments optimization module 402 uses different shell levels for the foreground main region and the background regions. In unbounded scenes, different grid layout initialization strategies for foreground and background regions can be implemented for bounded scenes and for unbounded scenes in accordance with some embodiments.

For bounded scenes in which the scenes or the objects to reconstruct are enclosed in a known bounded region, the voxel layout can be initialized by optimization module 402 as a dense grid with hₗᵥ levels, and voxels unobserved by any training images can be removed. In some embodiments, the number of voxels for a bounded scene is ≤(2^{h}^{ₗᵥ})³ after initialization.

For unbounded scenes for which the scenes or the objects to reconstruct are not enclosed in a known bounded region, optimization module 402 can first split the space into the main region(s) and the unbounded background region(s), each with a different heuristic. Optimization module 402 can use training camera positions to determine a cuboid for the main region. The cuboid center can be set to average camera positions, and a radius can be set to the median distance between the cuboid center and the cameras. In a manner similar to that for bounded scenes, the optimization module 402 can initialize a dense grid with hₗᵥ levels for the main region. For the background region, the optimization module 402 can allocate hₒᵤₜ level of background shells (or regions) enclosing the main region, which means that the radius of the entire scene is 2^{h}^{ₒᵤₜ} of the main region. In each background shell level, the optimization module 402 starts with the coarsest voxel size, i.e., 4³−2³=56 voxels in each shell level. The optimization module 402 then iteratively subdivides shell voxels with the highest sampling rate and removes voxels unobserved by any training cameras. The process repeats until the ratio of the number of voxels in the background and the main regions is hᵣₐₜᵢₒ. In some embodiments, the number of voxels is ≤(1+hᵣₐₜᵢₒ)(2^{h}^{ₗᵥ})³ after initialization.

At step 1106, optimization module 402 samples a view associated with an image from a set of training images and renders an image from the sampled view using the voxel representation. The set of training images can include any suitable number of images of the scene being reconstructed. In some embodiments, the image can be rendered at step 1106 according to method 700, described above in conjunction with FIGS. 7-8. The initial grid layout generated in step 1104 coarsely covers the entire scene, and needs to be adaptively aligned to different levels of detail for the scene during training progress. Difference rendering can be used to iteratively trend voxel images to be closer to the captured image views. The process can begin with no colors in which the scene appears gray. The scene can then be compared with the actual picture and the difference can be used to update parameters of the voxels.

At step 1108, optimization module 402 computes a loss based on the rendered image and the image from the training images. Then, at step 1110, optimization module 402 updates the voxel representation based on the loss. In some embodiments, Mean Squared Error (MSE) and the Structural Similarity Index Measure (SSIM) are two distinct metrics used to evaluate the quality of a rendered image compared to a ground-truth image. While MSE measures absolute pixel differences, SSIM is designed to assess perceived quality based on the human visual system (HVS). MSE and SSIM can be used as the photometric loss between the rendered and the ground truth images. The overall training objective (i.e., loss) is summarized in Equation 9 as:

$$ℒ = {ℒ}_{m s e} + {λ}_{s s i m} {ℒ}_{s s i m} + + {λ}_{T} {ℒ}_{T} + {λ}_{d i s t} {ℒ}_{d i s t} + {λ}_{R} {ℒ}_{R} + {λ}_{t v} {ℒ}_{t v} , \qquad EQUATION 9$$

where λ are the loss weights, [symbol] _{T} encourages final ray transmittances to be either zero or one, [symbol] _{dist} is a distortion loss, [symbol] _{R} is a per-point RGB loss, and [symbol] ₜᵥ is a total variation loss on the sparse density grid of voxels. Using the loss of Equation 9, optimization module 402 updates parameters of the voxel representation, which as described can include color, and/or other geometric properties of each voxel in some embodiments.

At step 1112, optimization module 402 determines whether to prune and subdivide voxels in the voxel representation. In some embodiments, optimization module 402 periodically applies pruning and subdivision during training operations to every K training iterations (for example, every 50 training iterations in some embodiments, or every 1000 training iterations in some embodiments). In such cases, optimization module 402 periodically prunes voxels that are more likely to be allocated to empty space and periodically subdivides voxels into smaller voxels to cover finer detail for high percentage or high frequency appearance regions.

If optimization module 402 determines to prune and subdivide voxels, then method 1100 continues to step 1114, where optimization module 402 prunes voxels of the voxel representation based on blending weights associated with the voxels. In some embodiments, in order to prune voxels, optimization module 402 computes a maximum blending weight for each voxel. The blending weight can be computed using all training cameras in some embodiments. In some embodiments, the blending weight can be computed for each voxel by multiplying a transmittance by an alpha value. For example, the blending weight can be: Tᵢ·αᵢ, where Tᵢ is a transmittance of the voxel and αᵢ is an alpha value. In image rendering, the alpha value can determine a pixel's transparency or opacity, ranging from fully transparent to fully opaque, with values in between used to create semi-transparent pixels, blending the foreground and background colors. Optimization module 402 periodically prunes voxels based on the computer blending weight of the voxel. In some embodiments, optimization module 402 removes voxels with a maximum blending weight lower than a threshold value hₚᵣᵤₙₑ. The value of hₚᵣᵤₙₑ can help to balance higher frames per second (FPS) and faster processing time with quality. In some embodiments, optimization module 402 uses a value of hₚᵣᵤₙₑ=0.05 to balance speed and quality.

At step 1116, optimization module 402 subdivides voxels based on a training gradient loss. In some embodiments, optimization module 402 periodically subdivides voxels into 2×2 children voxels based on a training loss gradient. A voxel with a larger training loss gradient indicates that the voxel region requires finer voxels to model the scene (i.e., the voxel does not contribute much to any of the training views), and vice versa. Therefore, the optimization module 402 can accumulate subdivision priority v_{priority} for each voxel in Equation 10 as follows:

$${v}_{{priority}^{}} = {\sum }_{r ∈ R} ‖ α ( r ) \cdot \frac{\partial ℒ ( r )}{\partial α ( r )} ‖ , \qquad EQUATION 10$$

where R is the set of all training pixel rays throughout the h_{every} iterations (also referred to as every K iterations) and [symbol] (r) is the training loss of the ray. The gradient is weighted by alpha values contributed from the voxel to the ray. Higher priority indicates higher subdivision priority.

In order to prevent voxels from overfitting few pixels, in some embodiments, optimization module 402 sets the priority to zero for voxels with maximum sampling rate lower than a sampling rate threshold vᵣₐₜₑ<2hᵣₐₜₑ. Optimization module 402 selects voxels with priority above the top h_{percent} percent (also referred to as top P %) to subdivide. Therefore, in some embodiments the total number of voxels is increased by (h_{percent}·(8−1)) percent. This is true when an Octree layout is used and only leaf nodes in the Octree layout are kept without keeping ancestor node, so optimization module 402 can remove the source voxels once such voxels are subdivided.

In some embodiments, optimization module 402 subdivides h_{percent}=5 percent of the voxels with the highest priority 15 times during the training. Accordingly, the voxels are prevented from becoming too small during the subdivision process. In some embodiments, the number of voxels increase at each subdivision, so the merit of subdividing more voxels each time can be marginal in some implementations as compared to earlier subdivisions. In some embodiments, the value of h_{percent} can be changed as training iterations progress.

In some embodiments, optimization module 402 also updates voxel properties when pruning or subdividing at steps 1114 or 1116, respectively. When the voxels are pruned and subdivided, the SH coefficients and the grid point densities of the voxels need to be updated accordingly. The SH coefficients are simply pruned together with voxels during pruning and are duplicated to the subdivided children voxels. Grid point densities are slightly more complex, as the eight voxel corner grid points of each voxel are shared between adjacent voxels. In some embodiments, optimization module 402 removes a grid point only when the grid point does not belong to any other corners of remaining voxels. When subdividing, optimization module 402 can use trilinear interpolation to compute the densities of the new grid points, and the duplicated grid points are merged and associated densities are averaged.

After step 1116, or if optimization module 402 determines to not prune and subdivide voxels, method 1100 continues to step 1118, where optimization module 402 determines whether to continue iterating. Optimization module 402 can determine whether to continue iterating in any technically feasible manner in some embodiments. For example, in some embodiments, optimization module 402 can iterate for a predefined number of iterations, until the loss plateaus, and/or the like. If optimization module 402 determines to continue iterating, then method 1100 returns to step 1106, where optimization module 402 samples another view associated with an image from the training images and renders an image from the sampled view using the voxel representation. On the other hand, if optimization module 402 determines to stop iterating, then method 1100 ends.

In some embodiments, once a voxel representation is generated, the sparse voxels of the voxel representation can be seamlessly integrated with grid based algorithms. For example, to extract a mesh, Marching Cubes can be used to extract triangles of an isosurface over density from the sparse voxels. Duplicated vertices from adjacent voxels can be merged to produce a unique set of vertices. When adjacent voxels belong to different Octree levels, the extracted triangle may not be connected as the density field is not continuous for voxels in different levels. Such discontinuities can be removed by simply subdividing all voxels to the finest level according to some embodiments.

Deciding a target level set for extracting an isosurface can be tricky for the density field. Instead, in accordance with some embodiments, sparse voxel truncated signal distance function fusion (TSDF-Fusion) can be implemented to compute truncated signed distance values of the sparse grid points. The surface of the zero-level set can be directly extracted using sparse voxel Marching Cubes. In some embodiments, signed distance fields can be directly modeled. The sparse voxel TSDF-fusion can directly initialize sparse voxel representation from sensor depth.

In sum, various embodiments include techniques for generating a set of voxels to represent a scene. A size of each voxel in the set of voxels is based on a level of detail in a corresponding portion of the scene. That is, the voxels are adaptively fit into the different sizes for different levels of detail in the scene rather than using uniform size voxels. The voxels are used to represent 3D scenes using efficient rasterization-based rendering, while ensuring that rendering occurs in the correct order. Scene optimization is implemented so that the voxels are adaptively fit into different scene levels of detail, and the scenes are reproduced with good rendering quality.

At least one technical advantage of disclosed techniques relative to the prior art is that the disclosed techniques allow for relatively fast frame per second rendering. Another technical advantage is that the disclosed techniques can be used to render higher quality images that include fewer popping artifacts than images rendered from the Gaussians of 3DGS approaches. In addition, the disclosed techniques provide a well-defined volume due to the different voxel sizes, making the voxels compatible with various computer graphics algorithms such as, for example, marching cubes techniques and truncated signal distance function fusion. These technical advantages provide one or more technological improvements over prior art approaches.

1. In some embodiments, a computer-implemented method for rendering an image comprises allocating a plurality of voxels to represent a scene, sorting the plurality of voxels based on a plurality of associated Morton codes to obtain a rendering order, and rendering the plurality of voxels based on the rendering order to generate an image.

2. The computer-implemented method of clause 1, wherein the plurality of voxels are allocated based on an octree layout without ancestor nodes.

3. The computer-implemented method of clauses 1 or 2, further comprising projecting the plurality of voxels onto an image space, and assigning each voxel included in the plurality of voxels to zero or more image tiles covered by the voxel.

4. The computer-implemented method of any of clauses 1-3, wherein the sorting further comprises sorting voxels assigned to each image tile in a near to far order for the image tile.

5. The computer-implemented method of any of clauses 1-4, further comprising pre-computing a color value and a normal value for each voxel, wherein rendering the plurality of voxels is further based on the color value and the normal value that are pre-computed for each voxel.

6. The computer-implemented method of any of clauses 1-5, wherein a first set of the voxels included in the plurality of voxels are each a first size and wherein a second set of the voxels included in the plurality of voxels are each a second size, and wherein the second size is greater than the first size.

7. The computer-implemented method of any of clauses 1-6, wherein the plurality of associated Morton codes include a plurality of direction-dependent Morton codes.

8. The computer-implemented method of any of clauses 1-7, wherein, in the plurality of voxels, one or more colors are represented using one or more voxel spherical harmonic coefficients.

9. The computer-implemented method of any of clauses 1-8, wherein rendering the plurality of voxels comprises shooting a ray through each voxel included in one or more voxels included in the plurality of voxels, sampling one or more points inside each voxel included in the one or more voxels based on the ray that is shot through the voxel, and determining at least one of an alpha value, a view dependent color value, a normal value, or a depth value based on the sampling.

10. The computer-implemented method of any of clauses 1-9, wherein allocating the plurality of voxels comprises performing an optimization technique based on one or more images of the scene.

11. In some embodiments, one or more non-transitory computer readable media include instructions that, when executed, cause a processor to allocate a plurality of voxels to represent a scene, sort the plurality of voxels based on a plurality of associated Morton codes to obtain a rendering order, and render the plurality of voxels based on the rendering order to generate an image.

12. The one or more non-transitory computer readable media of clause 11, wherein the plurality of voxels are allocated based on an octree layout without ancestor nodes.

13. The one or more non-transitory computer readable media of clauses 11 or 12, wherein the instructions, when executed, further cause the processor to project the plurality of voxels onto an image space, and assign each voxel included in the plurality of voxels to zero or more image tiles covered by the voxel.

14. The one or more non-transitory computer readable media of any of clauses 11-13, wherein the sorting further comprises sorting voxels assigned to each image tile in a near to far order for the image tile.

15. The one or more non-transitory computer readable media of any of clauses 11-14, wherein the instructions, when executed, further cause the processor to pre-compute a color value and a normal value for each voxel, wherein rendering the plurality of voxels is further based on the color value and the normal value that are pre-computed for each voxel.

16. The one or more non-transitory computer readable media of any of clauses 11-15, wherein rendering the plurality of voxels comprises shooting a ray through each voxel included in one or more voxels included in the plurality of voxels, sampling one or more points inside each voxel included in the one or more voxels based on the ray that is shot through the voxel, and determining at least one of an alpha value, a view dependent color value, a normal value, or a depth value based on the sampling.

17. The one or more non-transitory computer readable media of any of clauses 11-16, wherein the plurality of voxels are stored in a data structure that comprises a plurality of levels storing voxels having different sizes.

18. The one or more non-transitory computer readable media of any of clauses 11-17, wherein a first level included in the plurality of levels stores one or more voxels having one or more sides that are twice as long as one or more sides of one or more voxels stored in a second level included in the plurality of levels.

19. The one or more non-transitory computer readable media of any of clauses 11-18, wherein the plurality of voxels are allocated based on a plurality of images of the scene.

20. In some embodiments, a system comprises one or more memories storing instructions, and one or more processors that are coupled to the one or more memories and, when executing the instructions, are configured to allocate a plurality of voxels to represent a scene, sort the plurality of voxels based on a plurality of associated Morton codes to obtain a rendering order, and render the plurality of voxels based on the rendering order to generate an image.

1. In some embodiments, a computer-implemented method for representing a scene using voxels comprises initializing a first plurality of voxels that represent a scene, and performing one or more iterative optimization operations based on the first plurality of voxels and one or more images of the scene to generate a second plurality of voxels that represent the scene.

2. The computer-implemented method of clause 1, wherein initializing the first plurality of voxels comprises allocating the first plurality of voxels based on an octree layout without any ancestor nodes.

3. The computer-implemented method of clauses 1 or 2, wherein the one or more iterative optimization operations are further based on at least one of a photometric loss, a distortion loss, a per-point rgb (red, green, blue) loss, or a variation loss on a grid.

4. The computer-implemented method of any of clauses 1-3, wherein each voxel included in the second plurality of voxels is associated with at least one of a color value, an alpha value, a normal value, or a depth value.

5. The computer-implemented method of any of clauses 1-4, further comprising computing a blending weight of each voxel included in the first plurality of voxels, and pruning one or more voxels included in the first plurality of voxels based on the computed blending weights.

6. The computer-implemented method of any of clauses 1-5, further comprising subdividing one or more voxels included in the first plurality of voxels based on a training loss gradient.

7. The computer-implemented method of any of clauses 1-6, wherein initializing the first plurality of voxels comprises assigning a third plurality of voxels having a first size to a first region of the scene, and assigning a fourth plurality of voxels having a second size to a second region of the scene.

8. The computer-implemented method of any of clauses 1-7, wherein the first region of the scene is associated with more detail than the second region of the scene.

9. The computer-implemented method of any of clauses 1-8, wherein the second size is greater than the first size.

10. The computer-implemented method of any of clauses 1-9, further comprising rendering at least one image using the second plurality of voxels.

11. In some embodiments, one or more non-transitory computer readable media include instructions that, when executed, cause a processor to initialize a first plurality of voxels that represent a scene, and perform one or more iterative optimization operations based on the first plurality of voxels and one or more images of the scene to generate a second plurality of voxels that represent the scene.

12. The one or more non-transitory computer readable media of clause 11, wherein initializing the first plurality of voxels comprises allocating the first plurality of voxels based on an octree layout without any ancestor nodes.

13. The one or more non-transitory computer readable media of clauses 11 or 12, wherein the one or more iterative optimization operations are further based on at least one of a photometric loss, a distortion loss, a per-point rgb (red, green, blue) loss, or a variation loss on a grid.

14. The one or more non-transitory computer readable media of any of clauses 11-13, wherein each voxel included in the second plurality of voxels is associated with at least one of a color value, an alpha value, a normal value, or a depth value.

15. The one or more non-transitory computer readable media of any of clauses 11-14, wherein initializing the first plurality of voxels comprises assigning a third plurality of voxels having a first size to a first region of the scene, and assigning a fourth plurality of voxels having a second size to a second region of the scene.

16. The one or more non-transitory computer readable media of any of clauses 11-15, wherein the first region of the scene is associated with more detail than the second region of the scene.

17. The one or more non-transitory computer readable media of any of clauses 11-16, wherein the instructions, when executed, further cause the processor to sample the one or more images from a set of training images.

18. The one or more non-transitory computer readable media of any of clauses 11-17, wherein the instructions, when executed, further cause the processor to perform pruning and subdividing of one or more voxels a predetermined number of iterations after a last pruning and subdividing has been performed.

19. The one or more non-transitory computer readable media of any of clauses 11-18, wherein the instructions, when executed, further cause the processor to update at least one of voxel spherical harmonics coefficients or grid point densities associated with the second plurality of voxels after the pruning and subdividing.

20. In some embodiments, a system comprises one or more memories storing instructions, and one or more processors that are coupled to the one or more memories and, when executing the instructions, are configured to initialize a first plurality of voxels that represent a scene, and perform one or more iterative optimization operations based on the first plurality of voxels and one or more images of the scene to generate a second plurality of voxels that represent the scene.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and/or variations will be apparent to those of ordinary skill in the art without departing from the scope and/or spirit of the described embodiments.

Aspects of the present embodiments can be embodied as a system, method, or computer program product. Accordingly, aspects of the present disclosure can take the form of an entirely hardware embodiment, an entirely software embodiment (including firmware, resident software, micro-code, etc.) or an embodiment combining software and/or hardware aspects that can all generally be referred to herein as a “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described herein with reference to flowchart illustrations and/or block diagrams of methods, apparatus (systems) and/or computer program products according to embodiments of the disclosure. It will be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowcharts and/or block diagrams in the figures illustrate the architecture, functionality, and/or operation of possible implementations of systems, methods, and/or computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that perform the specified functions or acts, or combinations of special purpose hardware and/or computer instructions.

While the preceding is directed to embodiments of the present disclosure, other and/or further embodiments of the disclosure can be devised without departing from the basic scope thereof, and/or the scope thereof is determined by the claims that follow.

What is claimed is:

1. A computer-implemented method for rendering an image, the method comprising:
allocating a plurality of voxels to represent a scene;
sorting the plurality of voxels based on a plurality of associated Morton codes to obtain a rendering order; and
rendering the plurality of voxels based on the rendering order to generate an image.

2. The computer-implemented method of claim 1, wherein the plurality of voxels are allocated based on an octree layout without ancestor nodes.

3. The computer-implemented method of claim 1, further comprising:
projecting the plurality of voxels onto an image space; and
assigning each voxel included in the plurality of voxels to zero or more image tiles covered by the voxel.

4. The computer-implemented method of claim 1, wherein the sorting further comprises sorting voxels assigned to each image tile in a near to far order for the image tile.

5. The computer-implemented method of claim 1, further comprising pre-computing a color value and a normal value for each voxel, wherein rendering the plurality of voxels is further based on the color value and the normal value that are pre-computed for each voxel.

6. The computer-implemented method of claim 1, wherein a first set of the voxels included in the plurality of voxels are each a first size and wherein a second set of the voxels included in the plurality of voxels are each a second size, and wherein the second size is greater than the first size.

7. The computer-implemented method of claim 1, wherein the plurality of associated Morton codes include a plurality of direction-dependent Morton codes.

8. The computer-implemented method of claim 1, wherein, in the plurality of voxels, one or more colors are represented using one or more voxel spherical harmonic coefficients.

9. The computer-implemented method of claim 1, wherein rendering the plurality of voxels comprises:
shooting a ray through each voxel included in one or more voxels included in the plurality of voxels;
sampling one or more points inside each voxel included in the one or more voxels based on the ray that is shot through the voxel; and
determining at least one of an alpha value, a view dependent color value, a normal value, or a depth value based on the sampling.

10. The computer-implemented method of claim 1, wherein allocating the plurality of voxels comprises performing an optimization technique based on one or more images of the scene.

11. One or more non-transitory computer readable media including instructions that, when executed, cause a processor to:
allocate a plurality of voxels to represent a scene;
sort the plurality of voxels based on a plurality of associated Morton codes to obtain a rendering order; and
render the plurality of voxels based on the rendering order to generate an image.

12. The one or more non-transitory computer readable media of claim 11, wherein the plurality of voxels are allocated based on an octree layout without ancestor nodes.

13. The one or more non-transitory computer readable media of claim 11, wherein the instructions, when executed, further cause the processor to:
project the plurality of voxels onto an image space; and
assign each voxel included in the plurality of voxels to zero or more image tiles covered by the voxel.

14. The one or more non-transitory computer readable media of claim 11, wherein the sorting further comprises sorting voxels assigned to each image tile in a near to far order for the image tile.

15. The one or more non-transitory computer readable media of claim 11, wherein the instructions, when executed, further cause the processor to pre-compute a color value and a normal value for each voxel, wherein rendering the plurality of voxels is further based on the color value and the normal value that are pre-computed for each voxel.

16. The one or more non-transitory computer readable media of claim 11, wherein rendering the plurality of voxels comprises:
shooting a ray through each voxel included in one or more voxels included in the plurality of voxels;
sampling one or more points inside each voxel included in the one or more voxels based on the ray that is shot through the voxel; and
determining at least one of an alpha value, a view dependent color value, a normal value, or a depth value based on the sampling.

17. The one or more non-transitory computer readable media of claim 11, wherein the plurality of voxels are stored in a data structure that comprises a plurality of levels storing voxels having different sizes.

18. The one or more non-transitory computer readable media of claim 17, wherein a first level included in the plurality of levels stores one or more voxels having one or more sides that are twice as long as one or more sides of one or more voxels stored in a second level included in the plurality of levels.

19. The one or more non-transitory computer readable media of claim 11, wherein the plurality of voxels are allocated based on a plurality of images of the scene.

20. A system comprising:
one or more memories storing instructions; and
one or more processors that are coupled to the one or more memories and, when executing the instructions, are configured to:
allocate a plurality of voxels to represent a scene,
sort the plurality of voxels based on a plurality of associated Morton codes to obtain a rendering order, and
render the plurality of voxels based on the rendering order to generate an image.
